(19) United States
(12) Patent Application Publication
(10) Pub. No.: US 2017/0228050 A1
(43) Pub. Date: Aug. 10, 2017

(54) STYLUS, TOUCH-CONTROL SYSTEM, AND METHOD FOR MANIPULATING TOUCH-CONTROL SYSTEM

(71) Applicant: JEN-CHIEH LIN, TAIPEI CITY (TW)

(72) Inventor: JEN-CHIEH LIN, TAIPEI CITY (TW)

(21) Appl. No.: 15/015,191

(22) Filed: Feb. 4, 2016

(51) Int. Cl. G06F 3/0354; G06F 3/041; G06F 3/044

(52) U.S. Cl. CPC G06F 3/03545; G06F 3/044; G06F 3/0416

(57) ABSTRACT

A stylus includes a circuit module, a battery module electrically connected to the circuit module, and a fine adjustment module. The circuit module has a circuit board and a variable resistor mounted on the circuit board. The fine adjustment module has a conductor and a conductive refill movably contact with the conductor. The conductor is connected to the circuit board and is electrically connected to the variable resistor via the conductor and the circuit board. The resistance value of the variable resistor can be adjusted to cause the stylus to output a first signal strength through the conductive refill. The conductive refill can be moved with respect to the conductor to enable the stylus to have a signal strength, which is X˜Y % of the first signal strength (80≦X≦100 and 100<Y≦120).

### BACKGROUND OF THE INVENTION

1. Field of the Invention

The instant invention relates to a stylus; in particular, to a stylus, a touch-control system, and a method for manipulating the touch-control system.

2. Description of Related Art

A signal strength outputted from a conventional active stylus is a fixed value, that is to say, the conventional active stylus is only applied to a specific touch-control panel, which is suitable to receive the signal strength outputted from the conventional active stylus. Thus, when a predetermined signal strength of a different touch-control panel (e.g., the touch-control panel of an iPad2 is different from that of an iPad) is different from the signal strength outputted from the conventional active stylus, the conventional active stylus cannot be used with the different touch-control panel. Or, when a screen protector having a thicker thickness (e.g., a glass screen protector) is adhered on the specific touch-control panel, the conventional active stylus cannot be used with the specific touch-control panel.

Specifically, when the signal strength outputted from the conventional active stylus is smaller than the predetermined signal strength of the touch-control panel, the touch-control panel cannot show a moving track of the conventional active stylus. When the signal strength outputted from the conventional active stylus is greater than the predetermined signal strength of the touch-control panel, a writing track of the conventional active stylus displayed on the touch-control panel easily has a disconnection problem or a drift problem, so that the writing track of the conventional active stylus displayed on the touch-control panel cannot be identical to a moving track of the conventional active stylus.

### SUMMARY OF THE INVENTION

The instant disclosure provides a stylus, a touch-control system, and a method for manipulating the touch-control system, which are provided for effectively improving the problem generated by the conventional active stylus.

The instant disclosure provides a touch-control system, comprising: a touch-control device having a touch-control panel, wherein the touch-control panel is provided to receive a predetermined signal strength; and a stylus detachably and electrically connected to the touch-control panel and comprising: a circuit module having a circuit board and a variable resistor mounted on the circuit board, wherein the variable resistor having a variable resistance value of a fixed range is configured to limit a signal strength outputted from the stylus in a specific range; a battery module electrically connected to the circuit module; and a fine adjustment module, comprising: a conductor connected to the circuit board, wherein the conductor is electrically connected to the variable resistor via the circuit board; and a conductive refill movably abutted against the conductor, wherein the conductive refill is electrically connected to the variable resistor via the conductor and the circuit board, wherein the stylus is configured to output a first signal strength via the conductive refill by adjusting a resistance value of the variable resistor, and the first signal strength corresponds to the predetermined signal strength of the touch-control panel; wherein the conductive refill is movable between a first position and a second position with respect to the conductor, such that a signal strength outputted from the stylus is adjustable between X˜Y % of the first signal strength by adjusting the relative position of the conductive refill and the conductor, 80≦X≦100 and 100<Y≦120; wherein when the signal strength outputted from the stylus is M % of the first signal strength and X≦M≦Y, the conductive refill of the stylus is configured to move on the touch-control panel along a moving track, and the moving track of the conductive refill is identical to a writing track displayed on the touch-control panel; wherein when the signal strength outputted from the stylus is N % of the first signal strength and M<N≦Y, the conductive refill of the stylus is configured to move on a screen protector adhered on the touch-control panel along a moving track, a thickness of the screen protector is smaller than or identical to 1 mm, and the moving track of the conductive refill is identical to a writing track displayed on the touch-control panel.

Preferably, the stylus comprises a pen barrel, the circuit board and the variable resistor are arranged in the pen barrel, part of the conductive refill is arranged outside the pen barrel, the circuit module has a rough adjustment unit for adjusting the resistance value of the variable resistor, and part of the rough adjustment unit is manipulatable and is exposed from the pen barrel. The pen barrel has a thru-hole corresponding in position to the variable resistor, the variable resistor is a knob mode, the rough adjustment unit has a knob and is arranged in the thru-hole of the pen barrel, the knob has a combining end connected to the variable resistor and an operating end, the knob is configured to rotate the variable resistor by rotating the operating end, thereby adjusting the resistance value of the variable resistor. The stylus comprises a pen cap having a screwdriver structure, the pen cap is configured to receive the part of the conductive refill arranged outside the pen barrel or to insert the screwdriver structure into the thru-hole to engage with the operating end of the knob for rotating the knob.

The instant disclosure also provides a method for manipulating the above touch-control system, comprising: implementing a rough adjustment step, wherein the screwdriver structure of the pen cap is engaged with the operating end of the knob, and the pen cap is rotated to rotate the knob so as to adjust the resistance value of the variable resistor until the stylus outputs the first signal strength corresponding to the predetermined signal strength of the touch-control panel; and implementing a fine adjustment step, wherein the relative position of the conductive refill and the conductor is adjusted to fine adjust the first signal strength outputted from the stylus until a moving track of the conductive refill is identical to a writing track displayed on the touch-control panel; or when a screen protector is adhered on the touch-control panel and a thickness of the screen protector is smaller than or identical to lmm, the relative position of the conductive refill and the conductor is adjusted to fine adjust the first signal strength outputted from the stylus until a moving track of the conductive refill is identical to a writing track displayed on the touch-control panel.

The instant disclosure further provides a stylus, comprising: a circuit module having a circuit board and a variable resistor mounted on the circuit board, wherein the variable resistor having a variable resistance value of a fixed range is configured to limit a signal strength outputted from the stylus in a specific range; a battery module electrically connected to the circuit module; and a fine adjustment module, comprising: a conductor connected to the circuit board, wherein the conductor is electrically connected to the variable resistor via the circuit board; and a conductive refill movably abutted against the conductor, wherein the conductive refill is electrically connected to the variable resistor via the conductor and the circuit board, wherein the stylus is configured to output a first signal strength via the conductive refill by adjusting a resistance value of the variable resistor; wherein the conductive refill is movable between a first position and a second position with respect to the conductor, such that a signal strength outputted from the stylus is adjustable between X˜Y % of the first signal strength by adjusting the relative position of the conductive refill and the conductor, 80≦X≦100 and 100<Y≦120.

In summary, the stylus, the touch-control system, and the method of the instant embodiment can adjust the signal strength outputted from the stylus by using the rough adjustment unit or the fine adjustment module, such that the stylus of the instant embodiment can be used with different touch-control panels, which are provided for receiving different signal strengths, or can be used with a touch-control panel, which is provided with a screen protector adhered thereon.

In order to further appreciate the characteristics and technical contents of the instant invention, references are hereunder made to the detailed descriptions and appended drawings in connection with the instant invention. However, the appended drawings are merely shown for exemplary purposes, rather than being used to restrict the scope of the instant invention.

### BRIEF DESCRIPTION OF THE DRAWINGS

FIG. 1 is a perspective view showing a touch-control system according to the instant disclosure;

FIG. 2 is a perspective view showing a stylus according to the instant disclosure;

FIG. 3 is an exploded view of FIG. 2;

FIG. 4 is an exploded view of FIG. 2 from another perspective;

FIG. 5 is a cross-sectional view of FIG. 2;

FIG. 6 is a cross-sectional view showing the stylus when the conductive refill is located at a first position;

FIG. 7 is a cross-sectional view showing the stylus when the conductive refill is located at a second position;

FIG. 8 is a perspective view showing the touch-control system when the touch-control device is provided without any screen protector;

FIG. 9 is a perspective view showing the touch-control system when the touch-control device is provided with a screen protector;

FIG. 10 is a perspective view showing a first step of the method for manipulating the touch-control system;

FIG. 11 is a perspective view showing a second step of the method for manipulating the touch-control system;

FIG. 12 is a perspective view showing a third step of the method for manipulating the touch-control system;

FIG. 13 is a perspective view showing a stylus according to the other embodiment of the instant disclosure;

FIG. 14 is an exploded view of FIG. 13;

FIG. 15 is an exploded view of FIG. 13 from another perspective; and

FIG. 16 is a perspective view showing the stylus when the operating key is moved.

### DETAILED DESCRIPTION OF THE PREFERRED EMBODIMENTS

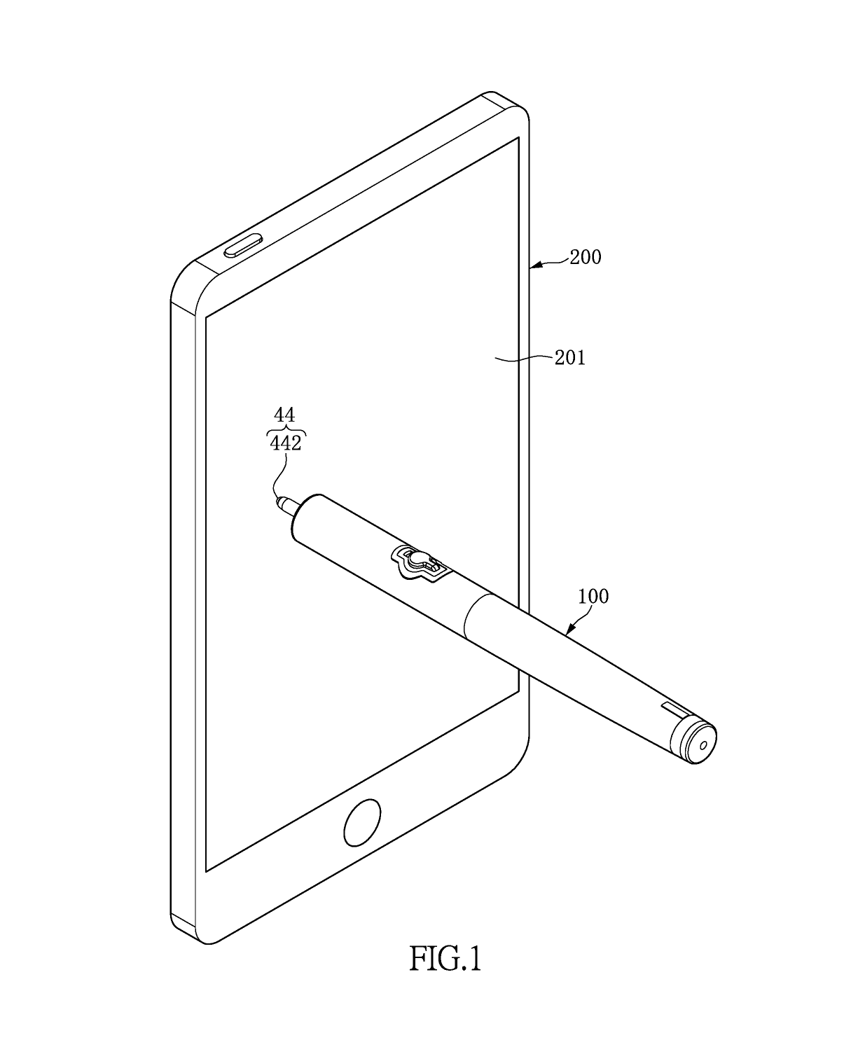

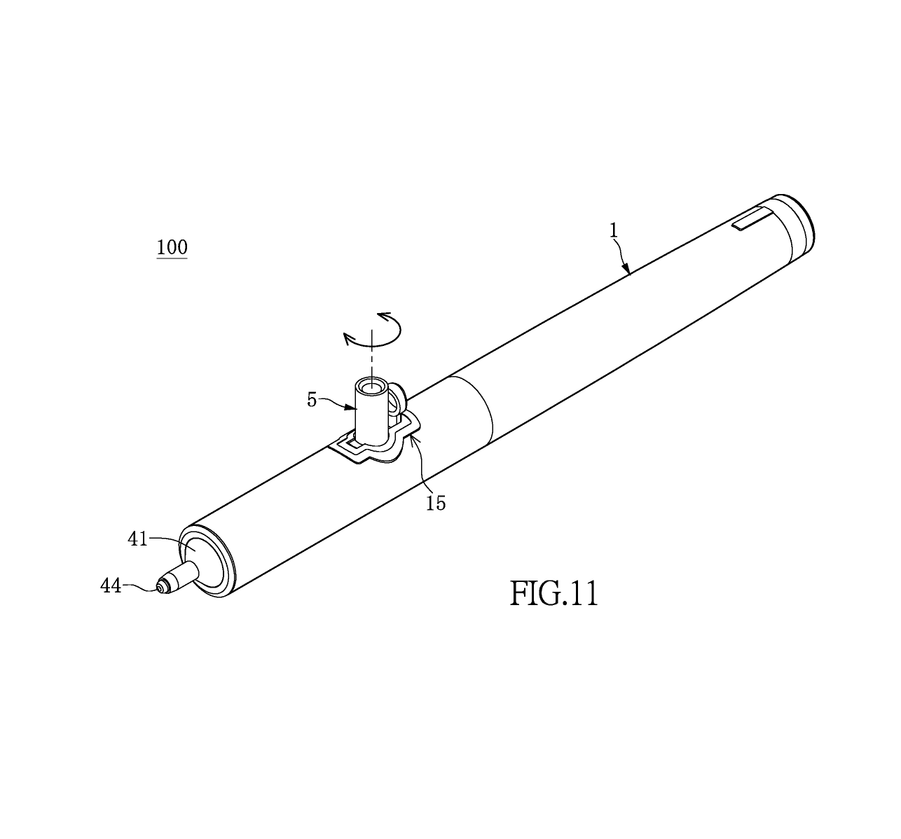

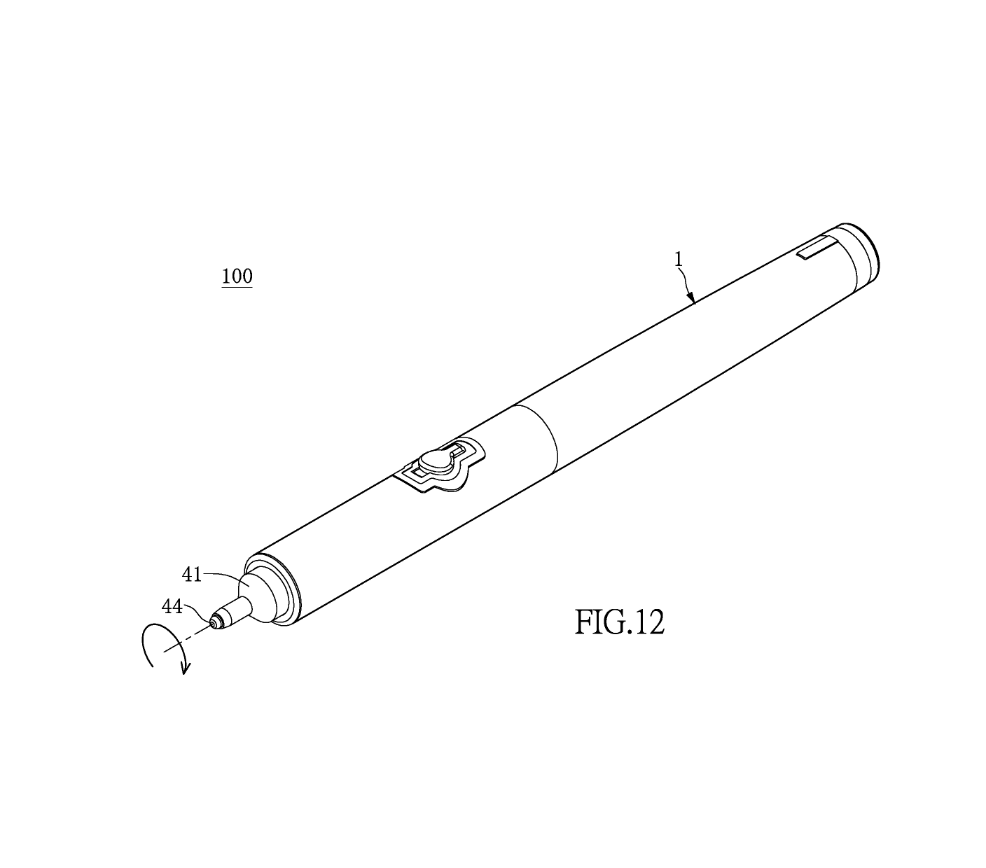

Please refer to FIGS. 1 through 12, which show a first embodiment of the instant disclosure. References are hereunder made to the detailed descriptions and appended drawings in connection with the instant invention. However, the appended drawings are merely shown for exemplary purposes, rather than being used to restrict the scope of the instant invention.

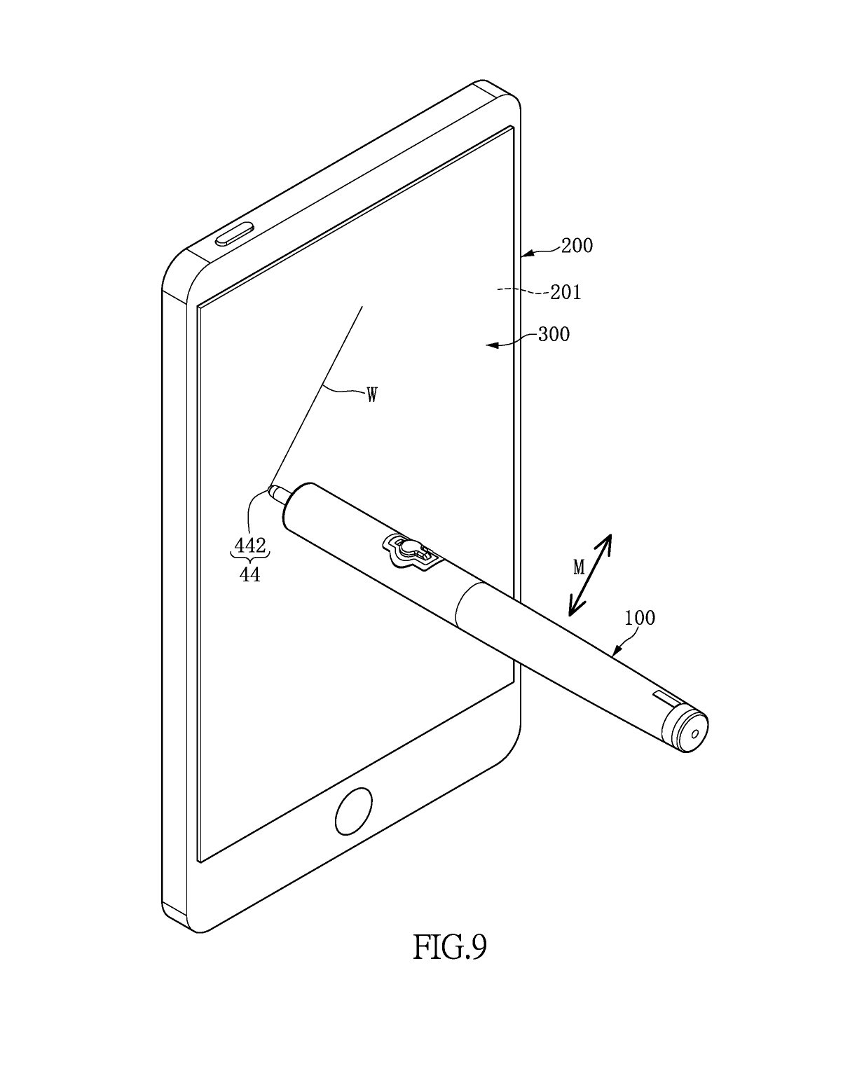

As shown in FIG. 1, the instant embodiment provides a touch-control system and a method for manipulating the touch-control system. The following description discloses the touch-control system, and then discloses the method. The touch-control system includes a stylus 100 and a touch-control device 200 cooperated with the stylus 100. In order to clearly realize the instant embodiment, the following description sequentially discloses the stylus 100, the relationship between the stylus 100 and the touch-control device 200, and the method. Additionally, the touch-control system in the instant embodiment can further include a screen protector 300 (as shown in FIG. 9), but is not limited thereto.

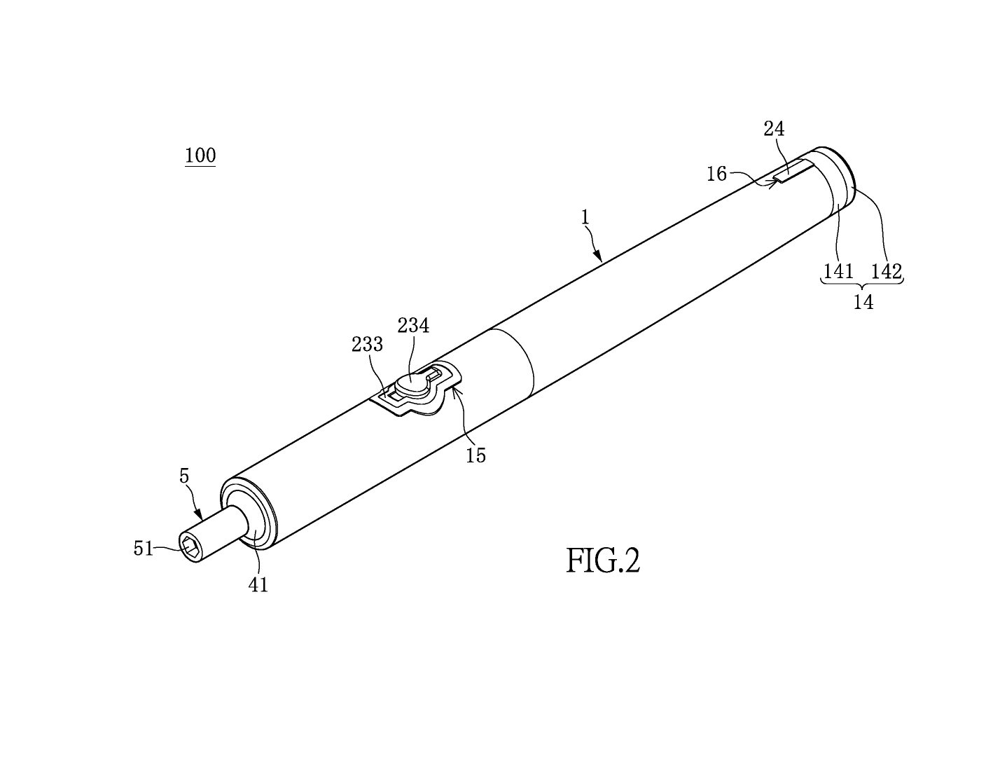

As shown in FIGS. 2 through 4, the stylus 100 in the instant embodiment means an active stylus 100, which can emit a signal. In other words, the stylus 100 in the instant embodiment does not include a passive stylus. The stylus 100 includes a pen barrel 1, a circuit module 2, a battery module 3, a fine adjustment module 4, and a pen cap 5. The circuit module 2, the battery module 3, and the fine adjustment module 4 are approximately arranged in the pen barrel 1, and the pen cap 5 is detachably sleeved at the fine adjustment module 4 to receive part of the fine adjustment module 4 arranged outside the pen barrel 1 (i.e., a touch-control portion 442 of a conductive refill 44 disclosed in the following description). Moreover, the stylus 100 in the instant embodiment is provided with the pen cap 5, but is not limited thereto.

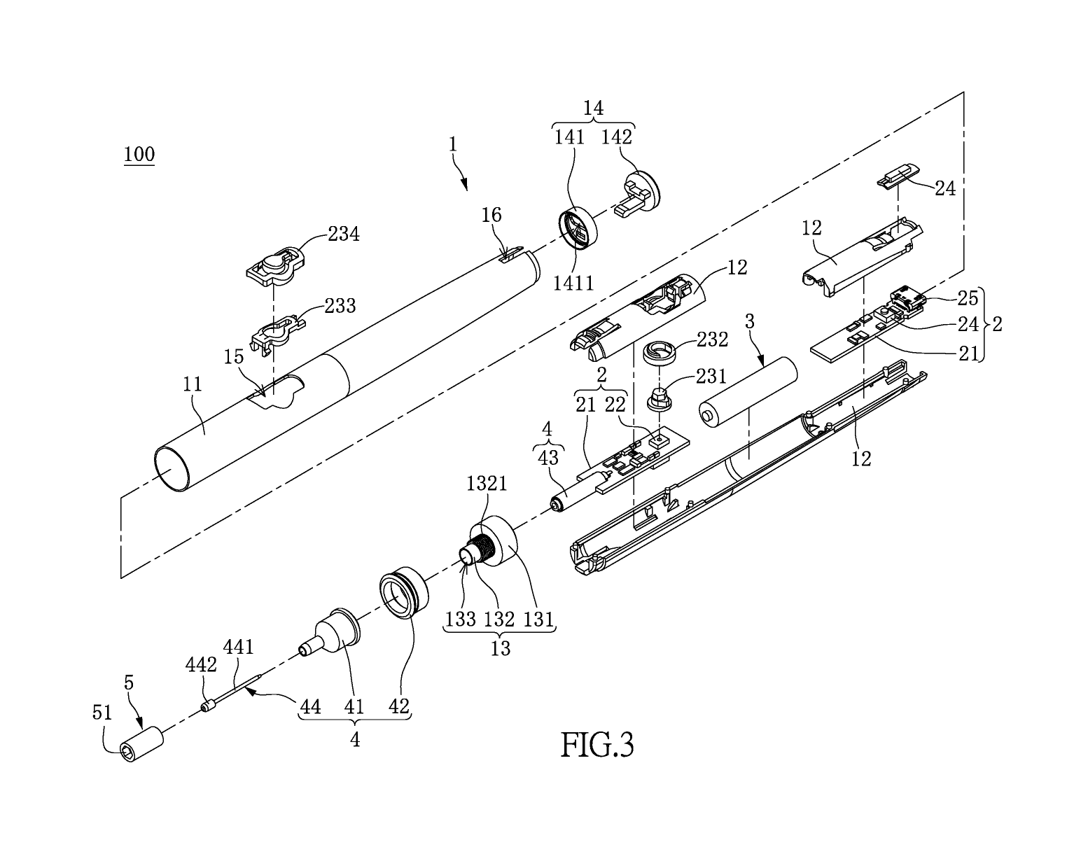

As shown in FIGS. 3 through 5, the pen barrel 1 has a pen tube 11, an inner frame 12 arranged in the pen tube 11, a head structure 13 arranged on one end thereof (i.e., the left end of the pen barrel 1 shown in FIG. 3), and a tail structure 14 arranged on the other end thereof (i.e., the right end of the pen barrel 1 shown in FIG. 3). The pen barrel 1 has a thru-hole 15 formed on the pen tube 11 and the inner frame 12, and the thru-hole 15 is arranged close to the head structure 13. The pen barrel 1 has an opening 16 formed on the pen tube 11 and the inner frame 12, and the opening 16 is arranged close to the tail structure 14.

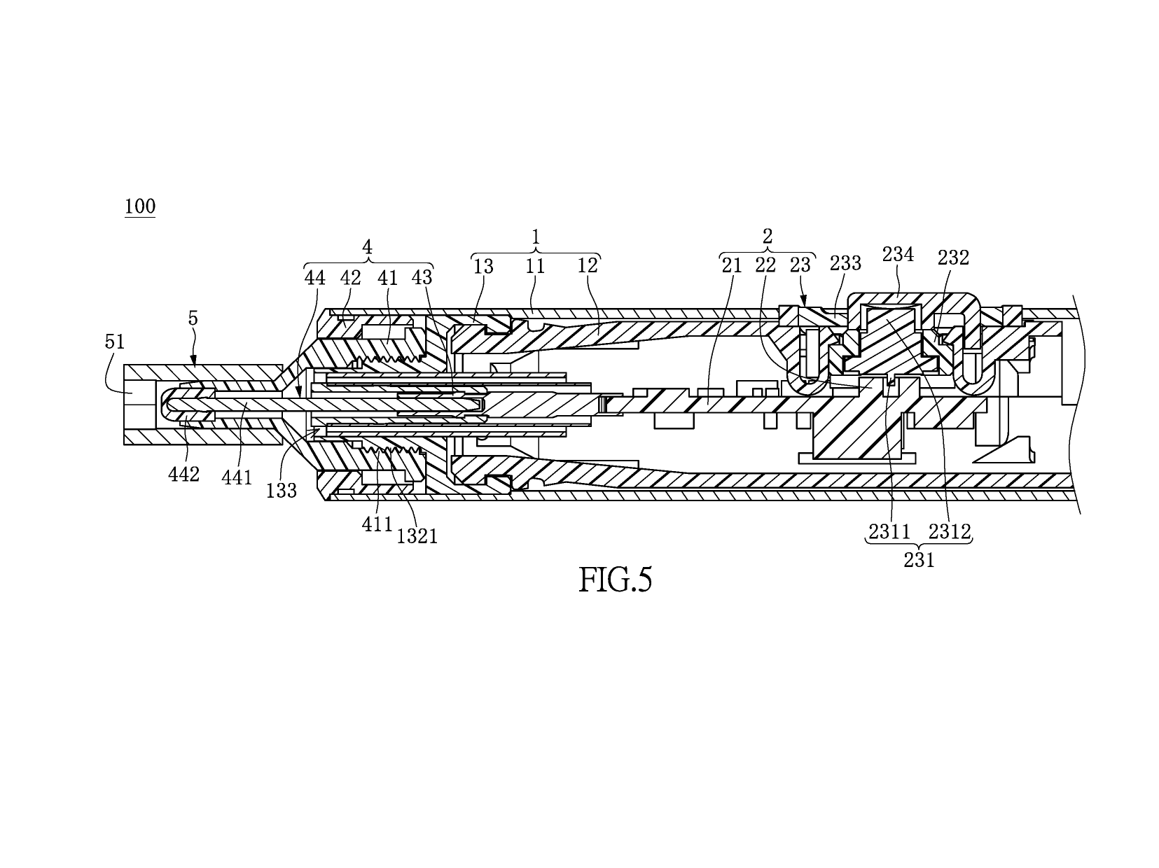

The head structure 13 includes a base portion 131 and a coupling portion 132. The base portion 131 is fixed on a front end of the inner frame 12 (i.e., the left end of the inner frame 12 shown in FIG. 5). The coupling portion 132 is integrally extended from the base portion 131 in a direction, which is away from the inner frame 12, and the coupling portion 132 has an external screw thread 1321 formed on an outer surface thereof. Moreover, the head structure 13 has a channel 133 in air communication with a space surrounded by the inner frame 12. The tail structure 14 has an end cover 141 and a dust-proofing plug 142. The end cover 141 is installed on a rear end of the pen tube 11, and the end cover 141 has a charging port 1411 in air communication with a space surrounded by the inner frame 12. The dust-proofing plug 142 is detachably inserted into the end cover 141 for sealing the charging port 1411.

The circuit module 2 includes a circuit board 21, a variable resistor 22 mounted on the circuit board 21, a rough adjustment unit 23 coupling with the variable resistor 22, a switch 24 electrically connected to the circuit board 21, and a charging unit 25 electrically connected to the circuit board 21. The circuit board 21 is received in the pen tube 11 and the inner frame 12 of the pen barrel 1, and the relative position of the circuit board 21 and the pen tube 11 is maintained by using the inner frame 12. The variable resistor 22 is arranged in the pen barrel 1 and is corresponding in position to the thru-hole 15 of the pen barrel 1, in other words, the variable resistor 22 is exposed from the pen barrel 1 via the thru-hole 15. The variable resistor 22 in the instant embodiment is in a knob mode, but is not limited thereto. The variable resistor 22 having a variable resistance value of a fixed range is configured to limit a signal strength outputted from the stylus 100 in a specific range. The rough adjustment unit 23 is approximately arranged in the thru-hole 15 of the pen barrel 1, and part of the rough adjustment unit 23 is manipulatable and is exposed from the pen barrel 1 via the thru-hole 15, so that the resistance value of the variable resistor 22 can be controlled by adjusting the rough adjustment unit 23.

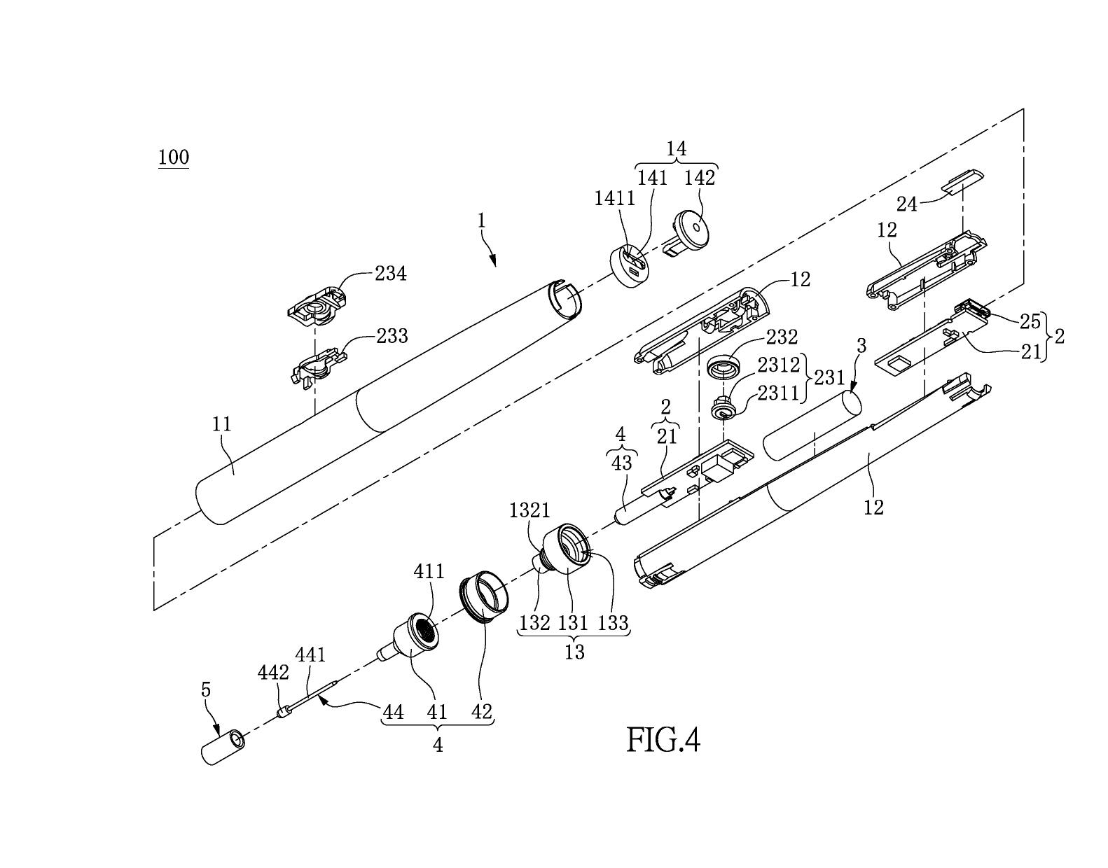

Specifically, the rough adjustment unit 23 has a knob 231, a limiting ring 232, a retainer 233, and a dust-proofing cover 234. The knob 231 has a combining end 2311 and an opposite operating end 2312 (as shown in FIG. 4), and the combining end 2311 is connected to the variable resistor 22, thus the knob 231 is configured to rotate the variable resistor 22 by rotating the operating end 2312, thereby adjusting the resistance value of the variable resistor 22. The limiting ring 232 is sleeved at the knob 231 to define a rotatable angle of the knob 231. The retainer 233 is installed on the inner frame 12 and part of the retainer 233 is arranged in the thru-hole 15, and the operating end 2312 of the knob 231 is arranged in the retainer 233. The dust-proofing cover 234 is installed on the pen tube 11 and is approximately arranged in the thru-hole 15. The dust-proofing cover 234 is detachably disposed on the operating end 2312 of the knob 231. The retainer 233 and the dust-proofing cover 234 can entirely close the thru-hole 15 for preventing dust or drop from flowing into the pen barrel 1 via the thru-hole 15.

Additionally, the variable resistor 22 in the instant embodiment is adjusted by using a structural means (i.e., the rough adjustment unit 23), but is not limited thereto. For example, the variable resistor 22 can be adjusted by using an electrical means (e.g., the rough adjustment unit is designed in an electronic mode).

The switch 24 is approximately arranged in the opening 16 of the pen barrel 1, and the switch 24 in the instant embodiment is a button, but is not limited thereto. The charging unit 25 is mounted on the circuit board 21, and the charging unit 25 is arranged in the pen barrel 1 and is corresponding in position to the charging port 1411 of the tail structure 14. Specifically, the charging unit 25 has an electrical connector for coupling with a mating connector (not shown).

The battery module 3 in the instant embodiment is at least one rechargeable battery, but is not limited thereto. The battery module 3 is received in the pen tube 11 and the inner frame 12 of the pen barrel 1, and the relative position of the battery module 3 and the pen tube 11 is maintained by using the inner frame 12. The battery module 3 is electrically connected to the circuit board 21 of the circuit module 2, thereby the battery module 3 can be electrically connected to any component mounted on the circuit board 21. For example, an operating energy of the stylus 100 is provided from the battery module 3, the switch 24 is manipulatable to control the battery module 3 for outputting energy, or an external energy (not shown) can be inputted into the battery module 3 by the charging unit 25 and the circuit board 21.

The fine adjustment module 4 includes a pen head 41, a stopper 42, a conductor 43, and a conductive refill 44. The pen head 41 has an internal screw thread 411 formed on an inner surface thereof, and the internal screw thread 411 of the pen head 41 is screwed on the external screw thread 1321 of the coupling portion 132 of the head structure 13, thus the pen head 41 is rotatable with respect to the head structure 13 for adjusting the relative position of the pen head 41 and the head structure 13. The stopper 42 is fixed on the front end of the pen tube 11, and the stopper 42 is configured to limit a movable distance of the pen head 41 for preventing the internal screw thread 411 of the pen head 41 from separating from the external screw thread 1321 of the head structure 13. The conductor 43 having a tube shape is inserted into the channel 133 of the head structure 13, and a portion of the conductor 43 arranged in the inner frame 12 is connected to the circuit board 21, thereby the conductor 43 is electrically connected to the variable resistor 22 via the circuit board 21.

The conductive refill 44 includes a rod 441 and a soft touch-control portion 442 fixed on an end of the rod 441, and the other end of the rod 441 is inserted into the conductor 43 and is movably abutted against the conductor 43. In other words, part of the conductive refill 44 is arranged outside the pen barrel 1. Moreover, the conductive refill 44 is electrically connected to the variable resistor 22 via the conductor 43 and the circuit board 21.

Part of the touch-control portion 442 is fixed in the pen head 41 and the other part of the touch-control portion 442 is arranged outside the pen head 41, thus when the pen head 41 is rotated with respect to the head structure 13, the pen head 41 moves the conductive refill 44 along a longitudinal direction of the pen barrel 1. In the instant embodiment, the rod 441 is made of metal, the touch-control portion 442 is made of an electrically conductive rubber, but the conductive refill 44 is not limited to the instant embodiment.

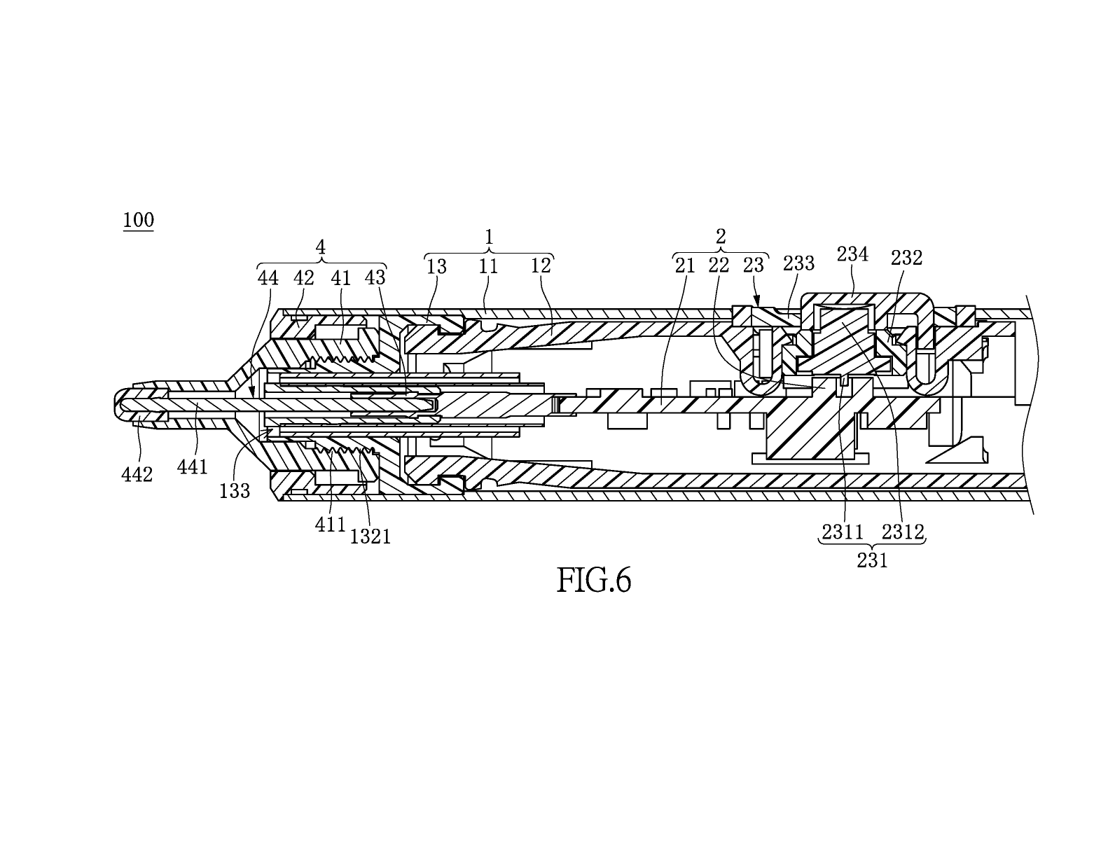

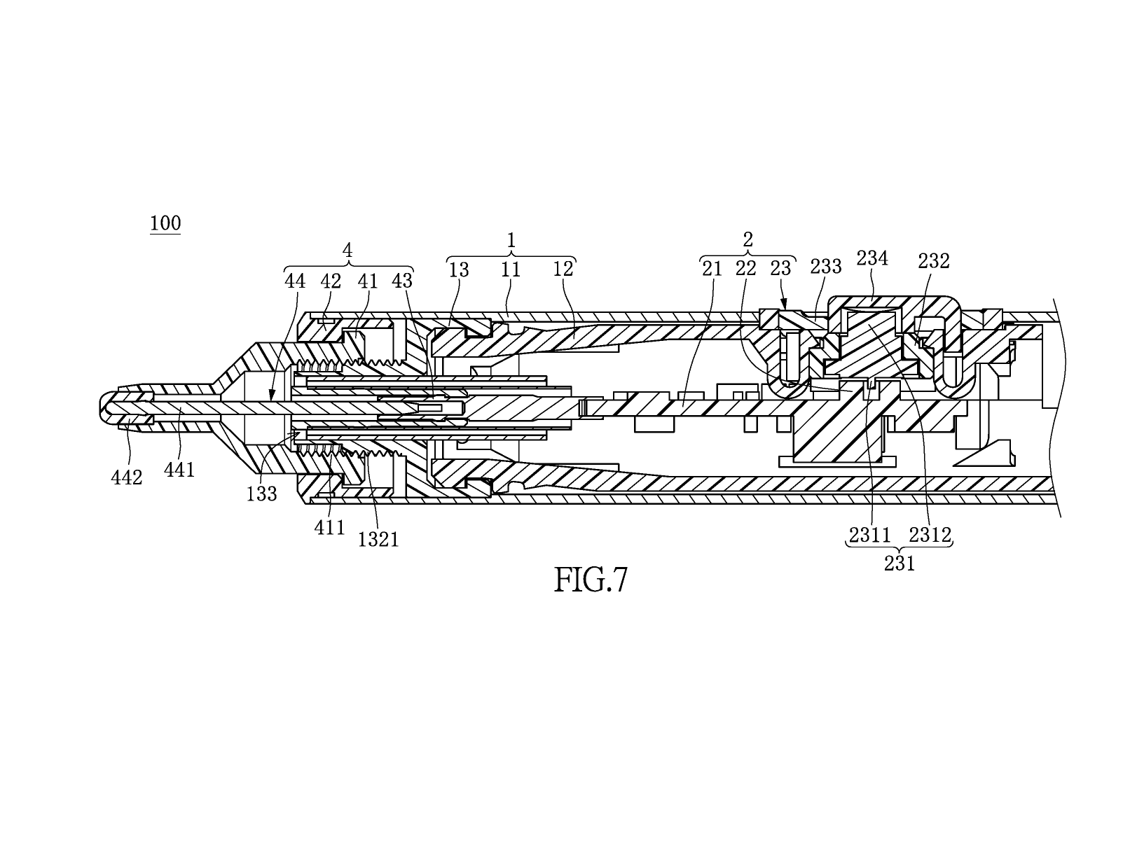

Specifically, the stylus 100 is configured to output a first signal strength via the conductive refill 44 by adjusting a resistance value of the variable resistor 22, the conductive refill 44 is movable between a first position (as shown in FIG. 6) and a second position (as shown in FIG. 7) with respect to the conductor 43 by rotating the pen head 41, such that a signal strength outputted from the stylus 100 is adjustable between X˜Y % of the first signal strength by adjusting the relative position of the conductive refill 44 and the conductor 43, 80≦X≦100 and 100<Y≦120.

Moreover, when the conductive refill 44 is located at the first position (as shown in FIG. 6), a distance between the conductive refill 44 and the variable resistor 22 is defined as a first distance, and the signal strength outputted from the stylus 100 is X % of the first signal strength. When the conductive refill 44 is located at the second position (as shown in FIG. 7), a distance between the conductive refill 44 and the variable resistor 22 is greater than the first distance and is defined as a second distance, and the signal strength outputted from the stylus 100 is Y % of the first signal strength.

The pen cap 5 is detachably disposed on the pen head 41 to receive the part of the touch-control portion 442 of the conductive refill 44 arranged outside the pen head 41. The pen cap 5 has a screwdriver structure 51 arranged on an end thereof away from the pen head 41, and the screwdriver structure 51 of the pen cap 5 conforms in shape to the operating end 2312 of the knob 231. The screwdriver structure 51 and the operating end 2312 in the instant embodiment are hexagon structures, which are engagable with each other, but are not limited thereto. Accordingly, the pen cap 5 is configured to insert the screwdriver structure 51 into the thru-hole 15 to engage with the operating end 2312 of the knob 231 for rotating the knob 231.

As shown in FIG. 1, the touch-control device 200 in the instant embodiment is a tablet PC or a smart phone, but is not limited thereto. Specifically, the touch-control device 200 includes a touch-control panel 201, and the touch-control panel 201 is provided to receive a predetermined signal strength. The stylus 100 can be used to output the first signal strength, which is corresponding to the predetermined signal strength of the touch-control panel 201, by adjusting the resistance value of the variable resistor 22, so the conductive refill 44 of the stylus 100 can be detachably and electrically connected to the touch-control panel 201 of the touch-control device 200.

Moreover, the signal strength outputted from the stylus 100 can be adjusted by controlling the rough adjustment unit 23 or the fine adjustment module 4, so that the stylus 100 can be used with different kinds of touch-control panels 201, which are provided for receiving different predetermined signal strengths. In other words, the stylus 100 is configured to output a second signal strength via the conductive refill 44 by adjusting a resistance value of the variable resistor 22, and the second signal strength corresponds to a predetermined signal strength of another touch-control panel (not shown), and a signal strength outputted from the stylus 100 is adjustable between X˜Y % of the second signal strength by adjusting the relative position of the conductive refill 44 and the conductor 43.

In addition, when a screen protector 300 (as shown in FIG. 9) is adhered on the touch-control panel 201, the predetermined signal strength of the touch-control panel 201 will be reduced according to the thickness of the screen protector 300. A problem, which is generated by adhering the screen protector 300 onto the touch-control panel 201, can be solved by adjusting the fine adjustment module 4 to control the stylus 100 to output a mating signal strength.

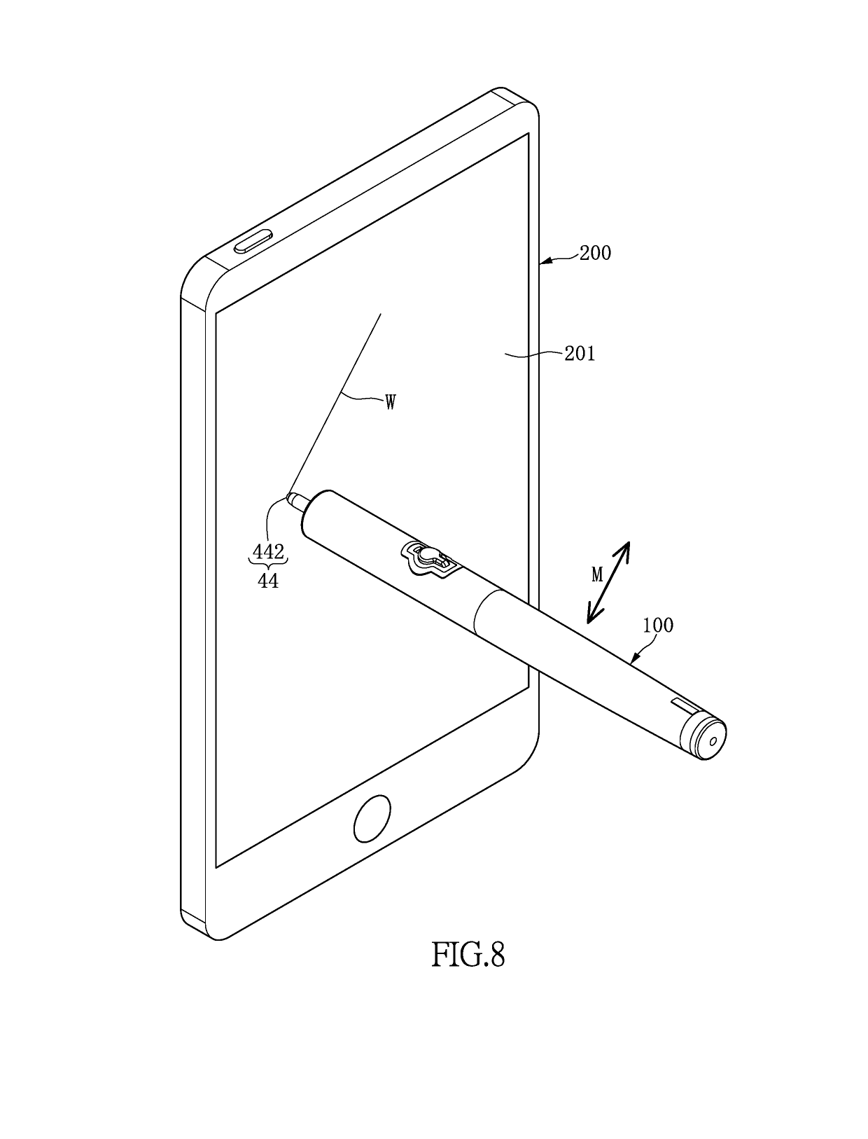

Specifically, as shown in FIG. 8, when the signal strength outputted from the stylus 100 is M % of the first signal strength and X≦M≦Y (e.g., the conductive refill 44 is located at the first position), the conductive refill 44 of the stylus 100 is configured to move on the touch-control panel 201 along a moving track M, and the moving track M of the conductive refill 44 is identical to a writing track W displayed on the touch-control panel 201. As shown in FIG. 9, when the signal strength outputted from the stylus 100 is N % of the first signal strength and M<N≦Y (e.g., the conductive refill 44 is located at the second position), the conductive refill 44 of the stylus 100 is configured to move on a screen protector 300 adhered on the touch-control panel 201 along a moving track M, a thickness of the screen protector 300 is smaller than or identical to 1 mm, and the moving track M of the conductive refill 44 is identical to a writing track W displayed on the touch-control panel 201. In the instant embodiment, M=X=80·N=Y=120, but M and N are not limited thereto.

The operation of the fine adjustment module 4 is approximately disclosed as follows. When the stylus 100 receives a signal transmitted from the touch-control panel 201, the signal travels through the circuit module 2, the conductor 43, and the conductive refill 44, and then the signal returns to the touch-control panel 201. The operation of the circuit module 2 has an antenna effect to change the strength of the signal, and when a path of the signal traveling through the stylus 100 is longer, the strength of the signal returns into the touch-control panel 201 is larger. Accordingly, a path of the signal traveling through the stylus 100 when the conductive refill 44 is located at the second position (as shown in FIG. 7) is greater than a path of the signal traveling through the stylus 100 when the conductive refill 44 is located at the first position (as shown in FIG. 6), so a signal strength outputted from the conductive refill 44 of the stylus 100 when the conductive refill 44 is located at the second position is greater than a signal strength outputted from the conductive refill 44 of the stylus 100 when the conductive refill 44 is located at the first position.

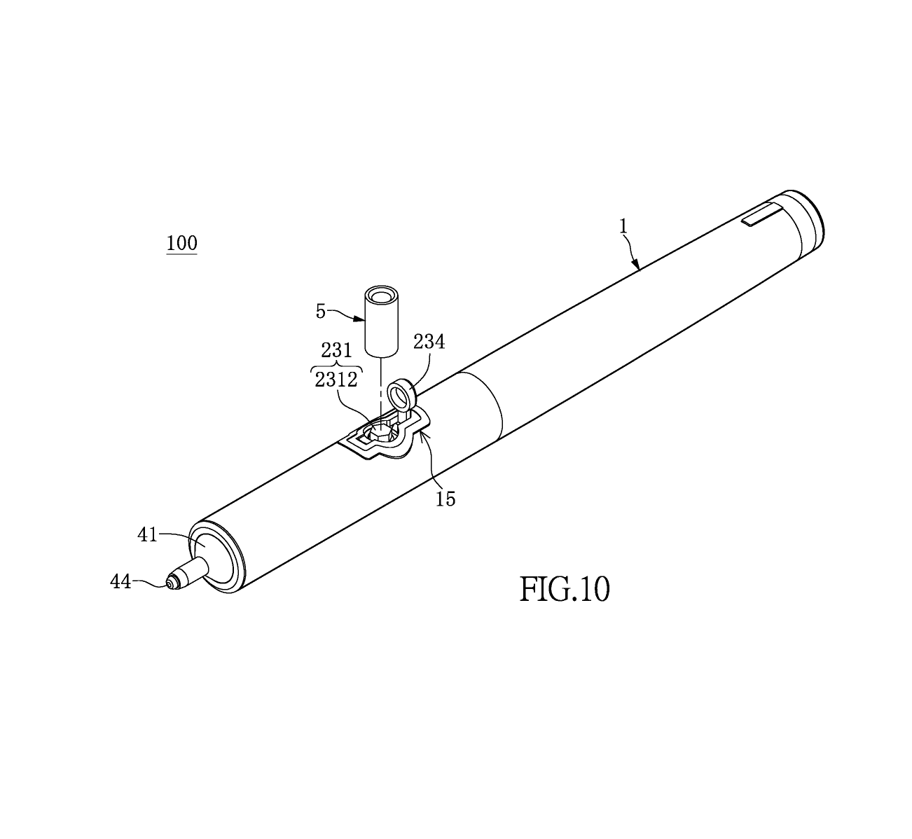

The construction of the touch-control system of the instant embodiment has been disclosed in the above description, and the following description discloses the method. Please refer to FIGS. 10 through 12, and with reference occasionally made to FIGS. 6 and 7. The method of the instant embodiment includes a rough adjustment step and a fine adjustment step. The sequence of the above two steps can be changed according to a user's demand, and the sequence of the two steps is not limited to the instant embodiment.

The rough adjustment step: a portion of the dust-proofing cover 234 covering the knob 231 is opened for exposing the operating end 2312 of the knob 231 from the pen barrel 1 via the thru-hole 15. The screwdriver structure 51 of the pen cap 5 is engaged with the operating end 2312 of the knob 231. The pen cap 5 is rotated to rotate the knob 231 so as to adjust the resistance value of the variable resistor 22 until the stylus 100 outputs the first signal strength corresponding to the predetermined signal strength of the touch-control panel 201. That is to say, the signal strength outputted from the stylus 100 can be adjusted according to the predetermined signal strength of the touch-control panel 201 of the touch-control device 200.

The fine adjustment step: the relative position of the conductive refill 44 and the conductor 43 is adjusted by rotating the pen head 41 to fine adjust the first signal strength outputted from the stylus 100 until a moving track M of the conductive refill 44 is identical to a writing track W displayed on the touch-control panel 201 (as shown in FIG. 8). Or, when a screen protector 300 is adhered on the touch-control panel 201 and a thickness of the screen protector 300 is smaller than or identical to 1 mm, the relative position of the conductive refill 44 and the conductor 43 is adjusted by rotating the pen head 41 to fine adjust the first signal strength outputted from the stylus 100 until a moving track M of the conductive refill 44 is identical to a writing track M displayed on the touch-control panel 201 (as shown in FIG. 9).

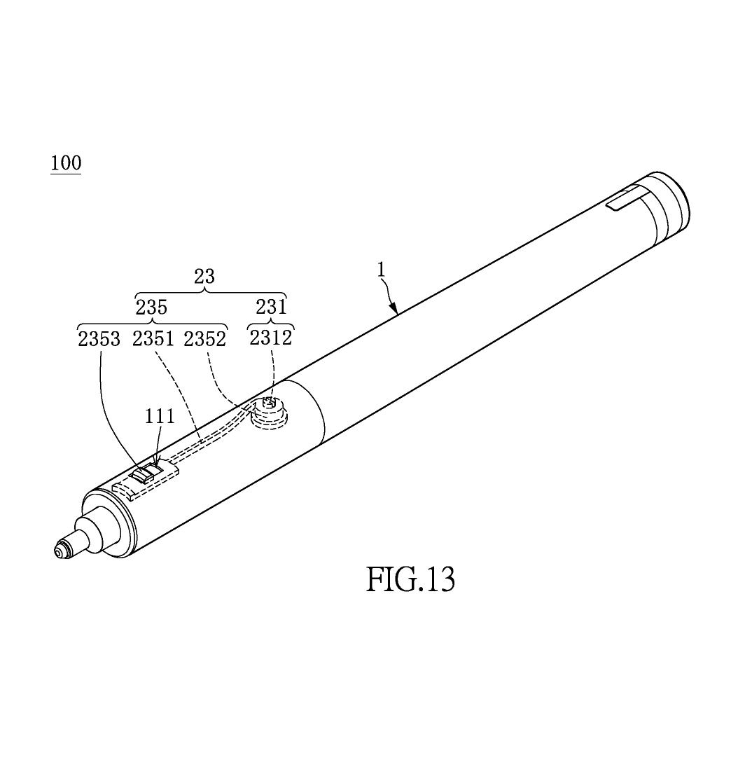

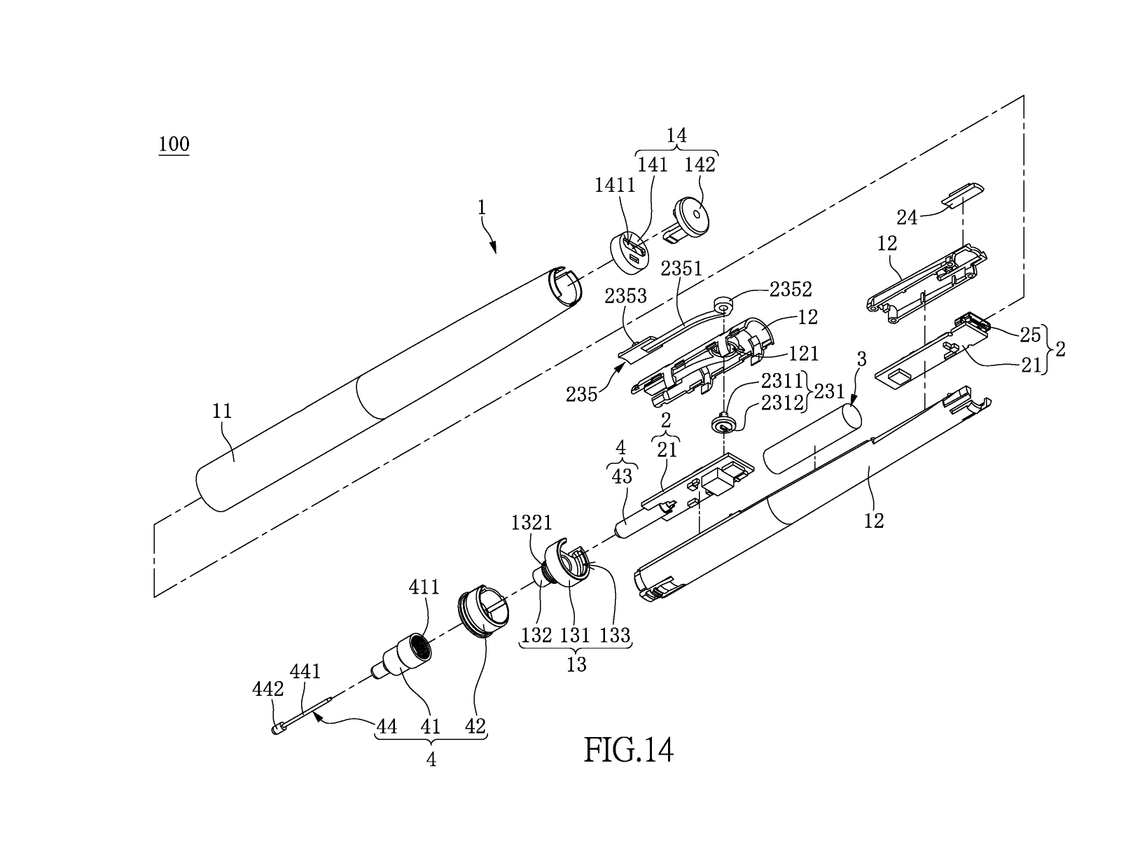

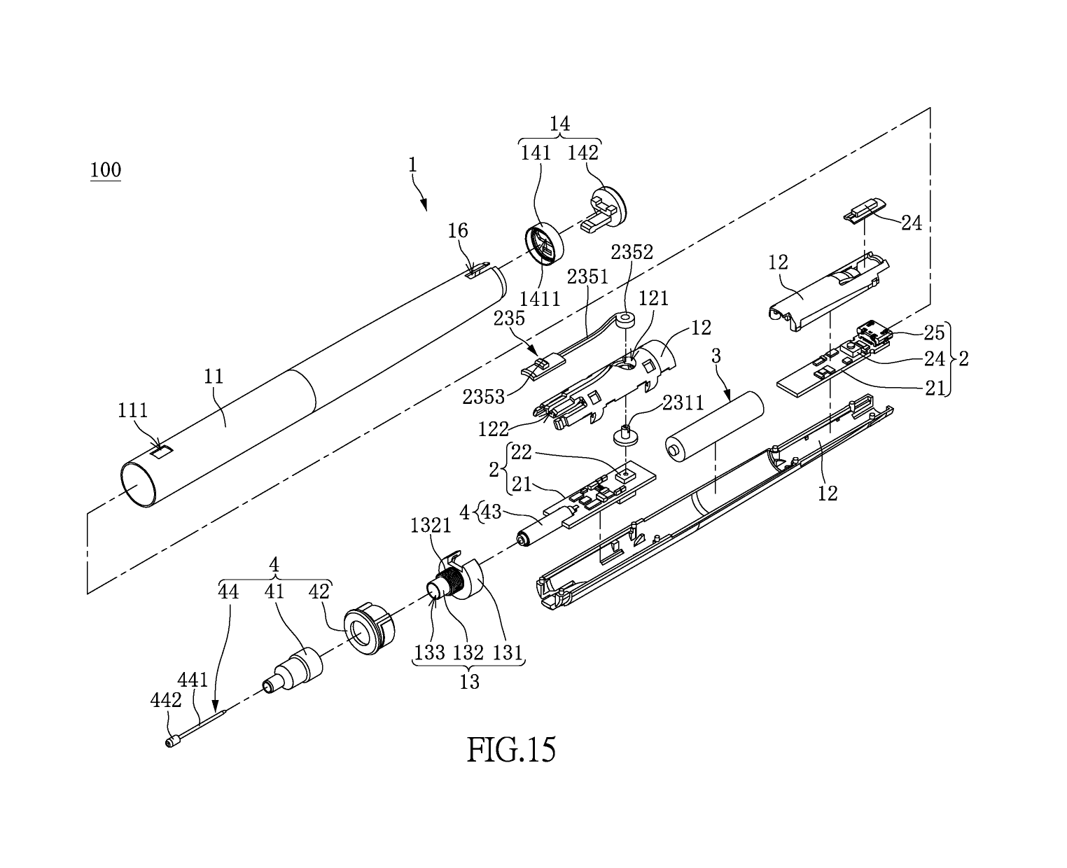

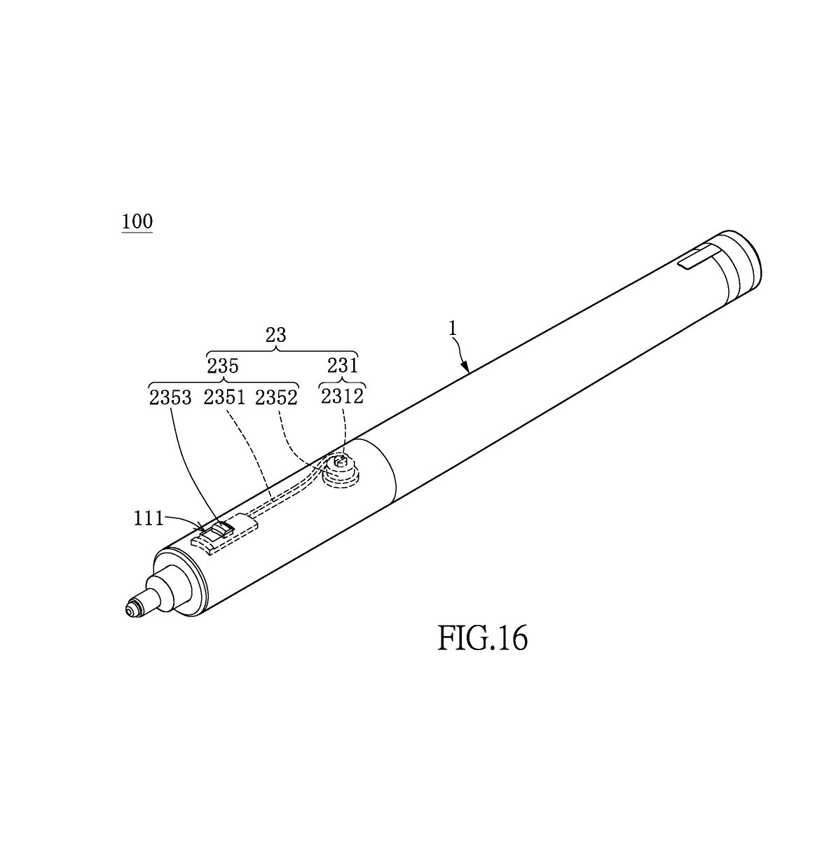

Please refer to FIGS. 13 through 16, which show a second embodiment of the instant disclosure. The second embodiment is similar to the first embodiment, so the same features are not disclosed again. The main different feature of the two embodiments is the rough adjustment unit 23 and some components related to the rough adjustment unit 23, which are disclosed as follows.

The rough adjustment unit 23 in the instant embodiment has a knob 231 and an adjusting member 235 detachably connected to the knob 231. That is to say, the rough adjustment unit 23 of the instant embodiment excludes the limiting ring 232, the retainer 233, and the dust-proofing cover 234. The knob 231 has a combining end 2311 and an opposite operating end 2312, and the combining end 2311 is connected to the variable resistor 22, thus the knob 231 is configured to rotate the variable resistor 22 by rotating the operating end 2312, thereby adjusting the resistance value of the variable resistor 22. The adjusting member 235 has a resilient strip 2351, a fixing portion 2352, and an operating key 2353, and the fixing portion 2352 and the operating key 2353 are integrally extended from two opposite ends of the strip 2351.

The inner frame 12 has an accommodating hole 121 and an accommodating groove 122 extended from the accommodating hole 121, and the accommodating hole 121 is corresponding in position to the knob 231. The fixing portion 2352 of the adjusting member 235 is fixed on the operating end 2312 of the knob 231, the fixing portion 2352 of the adjusting member 235 and the knob 231 are arranged in the accommodating hole 121, and the strip 2351 of the adjusting member 235 is arranged in the accommodating groove 122. The pen tube 11 has a thru-hole 111 corresponding in position to the operating key 2353. The operating key 2353 is movably arranged in the thru-hole 111 and is exposed from the pen tube 11 via the thru-hole 111. Moreover, a concave (not labeled) in air communication with the accommodating groove 122 can be formed on the base portion 131 of the head structure 13 and the stopper 42 for providing the movement of the operating key 2353, but the instant embodiment is not limited thereto.

Based on the above description, the stylus 100 of the instant embodiment can be used to adjust the resistance value of the variable resistor 22 by moving the operating key 2353 in the thru-hole 111. Specifically, the movement of the operating key 2353 deforms the strip 2351 to rotate the fixing portion 2352, thereby the knob 231 is rotated to adjust the resistance value of the variable resistor 22. Thus, the rough adjustment unit 23 of the stylus 100 in the instant embodiment is provided to simplify the rough adjustment step. In addition, if the stylus 100 in the instant embodiment is provided with a pen cap (not shown), the pen cap in the instant embodiment is provided without the screwdriver structure 51.

### [The Possible Effect of the Instant Disclosure]

In summary, the stylus, the touch-control system, and the method of the instant embodiment can adjust the signal strength outputted from the stylus by using the rough adjustment unit or the fine adjustment module, such that the stylus of the instant embodiment can be used with different touch-control panels, which are provided for receiving different signal strengths, or can be used with a touch-control panel, which is provided with a screen protector adhered thereon.

Moreover, the variable resistor of the stylus in the first embodiment can be exposed from the pen barrel via the thru-hole for providing a convenient operation to a user. The stylus is provided with the knob for coupling with the variable resistor, and the pen cap is provided with the screwdriver structure for detachably engaging with the knob, thus a user can easily adjust the resistance value of the variable resistor by using the cooperation of the screwdriver structure and the knob.

In addition, the stylus of the second embodiment can be used to adjust the resistance value of the variable resistor by moving the operating key in the thru-hole. Specifically, the movement of the operating key deforms the strip to rotate the fixing portion, thereby the knob is rotated to adjust the resistance value of the variable resistor. Thus, the rough adjustment unit of the stylus in the second embodiment is provided to simplify the rough adjustment step.

The descriptions illustrated supra set forth simply the preferred embodiments of the instant invention; however, the characteristics of the instant invention are by no means restricted thereto. All changes, alterations, or modifications conveniently considered by those skilled in the art are deemed to be encompassed within the scope of the instant invention delineated by the following claims.

What is claimed is:

1. A touch-control system, comprising:
a touch-control device having a touch-control panel, wherein the touch-control panel is provided to receive a predetermined signal strength; and
a stylus detachably and electrically connected to the touch-control panel and comprising:
a circuit module having a circuit board and a variable resistor mounted on the circuit board, wherein the variable resistor having a variable resistance value of a fixed range is configured to limit a signal strength outputted from the stylus in a specific range;
a battery module electrically connected to the circuit module; and
a fine adjustment module, comprising:
a conductor connected to the circuit board, wherein the conductor is electrically connected to the variable resistor via the circuit board; and
a conductive refill movably abutted against the conductor, wherein the conductive refill is electrically connected to the variable resistor via the conductor and the circuit board,
wherein the stylus is configured to output a first signal strength via the conductive refill by adjusting a resistance value of the variable resistor, and the first signal strength corresponds to the predetermined signal strength of the touch-control panel;
wherein the conductive refill is movable between a first position and a second position with respect to the conductor, such that a signal strength outputted from the stylus is adjustable between X˜Y % of the first signal strength by adjusting the relative position of the conductive refill and the conductor, 80≦X≦100 and 100<Y≦120;
wherein when the signal strength outputted from the stylus is M % of the first signal strength and X≦M≦Y, the conductive refill of the stylus is configured to move on the touch-control panel along a moving track, and the moving track of the conductive refill is identical to a writing track displayed on the touch-control panel;
wherein when the signal strength outputted from the stylus is N % of the first signal strength and M<N≦Y, the conductive refill of the stylus is configured to move on a screen protector adhered on the touch-control panel along a moving track, a thickness of the screen protector is smaller than or identical to 1 mm, and the moving track of the conductive refill is identical to a writing track displayed on the touch-control panel.

2. The touch-control system as claimed in claim 1, wherein the stylus comprises a pen barrel, the circuit board and the variable resistor are arranged in the pen barrel, part of the conductive refill is arranged outside the pen barrel, the circuit module has a rough adjustment unit for adjusting the resistance value of the variable resistor, and part of the rough adjustment unit is manipulatable and is exposed from the pen barrel.

3. The touch-control system as claimed in claim 2, wherein the pen barrel has a thru-hole corresponding in position to the variable resistor, the variable resistor is a knob mode, the rough adjustment unit has a knob and is approximately arranged in the thru-hole of the pen barrel, the knob has a combining end connected to the variable resistor and an operating end, the knob is configured to rotate the variable resistor by rotating the operating end, thereby adjusting the resistance value of the variable resistor.

4. The touch-control system as claimed in claim 3, wherein the stylus comprises a pen cap having a screwdriver structure, the pen cap is configured to receive the part of the conductive refill arranged outside the pen barrel or to insert the screwdriver structure into the thru-hole to engage with the operating end of the knob for rotating the knob.

5. The touch-control system as claimed in claim 2, wherein the rough adjustment unit has a knob and an adjusting member detachably connected to the knob, the adjusting member has a resilient strip, a fixing portion, and an operating key, and the fixing portion and the operating key are integrally extended from two opposite ends of the strip, the knob has a combining end connected to the variable resistor and an operating end connected to the fixing portion, the knob is configured to rotate the variable resistor by rotating the operating end, thereby adjusting the resistance value of the variable resistor.

6. The touch-control system as claimed in claim 5, wherein the pen barrel has a thru-hole, an accommodating hole, and an accommodating groove extended from the accommodating hole, the knob and the fixing portion of the adjusting member are arranged in the accommodating hole, the strip of the adjusting member is arranged in the accommodating groove, the operating key is movably arranged in the thru-hole and is exposed from the pen pen barrel via the thru-hole.

7. The touch-control system as claimed in claim 1, wherein when the conductive refill is located at the first position, a distance between the conductive refill and the variable resistor is defined as a first distance, and the signal strength outputted from the stylus is X % of the first signal strength; when the conductive refill is located at the second position, a distance between the conductive refill and the variable resistor is greater than the first distance and is defined as a second distance, and the signal strength outputted from the stylus is Y % of the first signal strength.

8. The touch-control system as claimed in claim 1, wherein the stylus is configured to output a second signal strength via the conductive refill by adjusting a resistance value of the variable resistor, and the second signal strength corresponds to a predetermined signal strength of another touch-control panel; wherein a signal strength outputted from the stylus is adjustable between X˜Y % of the second signal strength by adjusting the relative position of the conductive refill and the conductor.

9. A method for manipulating the touch-control system as claimed in claim 4, comprising:
implementing a rough adjustment step, wherein the screwdriver structure of the pen cap is engaged with the operating end of the knob, and the pen cap is rotated to rotate the knob so as to adjust the resistance value of the variable resistor until the stylus outputs the first signal strength corresponding to the predetermined signal strength of the touch-control panel; and
implementing a fine adjustment step, wherein the relative position of the conductive refill and the conductor is adjusted to fine adjust the first signal strength outputted from the stylus until a moving track of the conductive refill is identical to a writing track displayed on the touch-control panel; or when a screen protector is adhered on the touch-control panel and a thickness of the screen protector is smaller than or identical to 1 mm, the relative position of the conductive refill and the conductor is adjusted to fine adjust the first signal strength outputted from the stylus until a moving track of the conductive refill is identical to a writing track displayed on the touch-control panel.

10. A stylus, comprising:
a circuit module having a circuit board and a variable resistor mounted on the circuit board, wherein the variable resistor having a variable resistance value of a fixed range is configured to limit a signal strength outputted from the stylus in a specific range;
a battery module electrically connected to the circuit module; and
a fine adjustment module, comprising:
a conductor connected to the circuit board, wherein the conductor is electrically connected to the variable resistor via the circuit board; and
a conductive refill movably abutted against the conductor,
wherein the conductive refill is electrically connected to the variable resistor via the conductor and the circuit board,
wherein the stylus is configured to output a first signal strength via the conductive refill by adjusting a resistance value of the variable resistor; wherein the conductive refill is movable between a first position and a second position with respect to the conductor, such that a signal strength outputted from the stylus is adjustable between X˜Y % of the first signal strength by adjusting the relative position of the conductive refill and the conductor, 80≦X≦100 and 100<Y≦120.

11. The stylus as claimed in claim 10, further comprising a pen barrel, wherein the circuit board and the variable resistor are arranged in the pen barrel, part of the conductive refill is arranged outside the pen barrel, the circuit module has a rough adjustment unit for adjusting the resistance value of the variable resistor, and part of the rough adjustment unit is manipulatable and is exposed from the pen barrel.

12. The stylus as claimed in claim 11, further comprising a pen cap having a screwdriver structure arranged on an end thereof, wherein the pen cap is detachably disposed on the fine adjustment module to receive the part of the conductive refill arranged outside the pen barrel; the pen barrel has a thru-hole corresponding in position to the variable resistor, the variable resistor is a knob mode, the rough adjustment unit has a knob and is arranged in the thru-hole of the pen barrel, the knob has a combining end connected to the variable resistor and an operating end; when the pen cap is separated from the pen barrel, the pen cap is configured to insert the screwdriver structure into the thru-hole to engage with the operating end of the knob for rotating the knob.

13. The stylus as claimed in claim 11, wherein the rough adjustment unit has a knob and an adjusting member detachably connected to the knob, the adjusting member has a resilient strip, a fixing portion, and an operating key, and the fixing portion and the operating key are integrally extended from two opposite ends of the strip, the knob has a combining end connected to the variable resistor and an operating end connected to the fixing portion, the knob is configured to rotate the variable resistor by rotating the operating end, thereby adjusting the resistance value of the variable resistor.

14. The stylus as claimed in claim 13, wherein the pen barrel has a thru-hole, an accommodating hole, and an accommodating groove extended from the accommodating hole, the knob and the fixing portion of the adjusting member are arranged in the accommodating hole, the strip of the adjusting member is arranged in the accommodating groove, the operating key is movably arranged in the thru-hole and is exposed from the pen pen barrel via the thru-hole.
